(19) United States
(12) Patent Application Publication
(10) Pub. No.: US 2026/0081689 A1
(43) Pub. Date: Mar. 19, 2026

(54) SIGNAL PROCESSING APPARATUS AND SIGNAL PROCESSING METHOD

(71) Applicant: NTT, Inc., Tokyo (JP)

(72) Inventors: Koki SHIBAHARA, Musashino-shi (JP); Takayuki KOBAYASHI, Musashino-shi (JP); Yutaka MIYAMOTO, Musashino-shi (JP)

(73) Assignee: NTT, Inc., Tokyo (JP)

(21) Appl. No.: 19/108,687

(22) PCT Filed: Sep. 7, 2022
(86) PCT No.: PCT/JP2022/033577

§ 371 Date: Mar. 4, 2025

(51) Int. Cl. H04B 10/2507

(52) U.S. Cl. CPC H04B 10/2507

(57) ABSTRACT

According to an aspect of the present invention, there is provided a signal processing device including: a Fourier transform processing unit that converts an input signal into a frequency domain signal for each block having a size N; a multiplication processing unit that performs filtering processing on the converted frequency domain signal by using a filter weighting coefficient; an inverse Fourier transform processing unit that performs inverse Fourier transform processing on the frequency domain signal on which the filtering processing is performed; and an output signal selection unit that stores N/2+Δ symbols centered on an N/2-th output symbol from the head among output symbols having a size N which are obtained by performing inverse Fourier transform processing, and outputs a signal obtained by discarding output symbols other than the stored output symbols.

### TECHNICAL FIELD

The present invention relates to a technique of a signal processing device and a signal processing method.

### BACKGROUND ART

With the start of 5th generation (5G) services, high definition video service distribution, development of Internet of things (IoT) services, and the like in recent years, communication traffic flowing through an optical network has been increasing year by year. As a countermeasure for optical networks to meet the increasing demand for communication traffic, for example, without changing a structure of an optical fiber as a transmission line, countermeasures such as enhancement of functionality of an optical communication system device installed at a terminal station of the optical network and introduction of an optical amplifier and an optical switch have been taken.

As an optical fiber serving as a base of a current high-capacity optical network, a single mode fiber (SMF) is used except for a local network for a short distance such as a local area network (LAN). The single mode fiber is an optical fiber that includes a single core serving as a path of an optical signal in a clad and is designed to allow only single mode propagation in a wavelength band such as a C band or an L band used in a large-capacity long-distance optical network. Thereby, a large-capacity long-distance optical network that stably transfers information reaching several terabits per second over a long distance has been implemented.

In the optical network, a digital coherent transmission technique using a digital signal processing technique and a coherent transmission/reception technique is applied and introduced to an optical transmission device of a 100-gigabit-per-second class. The digital coherent transmission technique is a technique in which a coherent reception method and ultra-high-speed digital signal processing are combined. The coherent reception method is a reception method for detecting interference light between light on a reception side and local oscillation light. The ultra-high-speed digital signal processing is processing of reproducing an envelope waveform of an optical signal in a digital domain and equalizing waveform distortions generated in a transmission line and a transmitter/receiver.

By using the digital coherent transmission technique, waveform distortions can be effectively removed based on a model such as a physical mechanism which is a source of generation of the waveform distortions, and an optical transceiver that is small and inexpensive and has low power consumption is implemented. With the advent of the digital coherent transmission technique, not only the reception sensitivity at the time of optical transmission in a large-capacity optical network can be improved, but also the information transmission efficiency can be dramatically improved by information being superimposed on the amplitude, the phase, or the polarization of an optical carrier wave.

As an example of a more specific transmission method using the digital coherent transmission technique of superimposing information on polarized waves in an optical transmission system, there is polarization-multiplexed optical transmission using two modes of orthogonal polarized waves for a single mode fiber. In the polarization-multiplexed optical transmission, different pieces of information can be superimposed on polarization waves in an orthogonal relationship. When polarization-multiplexed optical transmission is performed, polarized waves in an orthogonal relationship are complicatedly mixed in an optical transmission line, and an orthogonal axis of a polarization mode varies at a high speed. For this reason, it is difficult to track such polarized waves using an optical device.

Therefore, a reception device that supports a polarization diversity structure receives a mixed polarization-multiplexed optical signal, converts the received polarization-multiplexed optical signal into a digital signal, and performs processing of separating the digital signal by using digital signal processing. This processing can be modeled as a 2×2 multiple-input multiple-output (MIMO) system used in a wireless communication system. Thereby, it is possible to extract information for each polarized wave from the separated signals, and communication between the transceivers is established.

As another example of the transmission method using the digital coherent transmission technique, there is mode-multiplexed optical transmission using a plurality of spatial modes (hereinafter, also referred to as “modes”) in a multi-mode optical fiber. In the mode-multiplexed optical transmission, for example, a fiber having a core diameter expanded compared with that of a single mode fiber is used as a transmission medium. Thereby, a plurality of modes can be excited even in an existing wavelength band such as the C band, and different pieces of information can be superimposed and transmitted in each of the modes.

Also in a case of the mode-multiplexed optical transmission, similarly to a case of the polarization-multiplexed optical transmission, mode-multiplexed optical signals are complicatedly mixed during propagation through a multi-mode optical fiber. A reception device that supports a mode diversity structure receives a mixed mode-multiplexed optical signal, converts the received mode-multiplexed optical signal into a digital signal, and performs separation using MIMO type signal processing of a scale corresponding to the number of modes to be excited.

As a more specific example, a multi-mode fiber that excites two linear polarized (LP) modes is considered. In the multi-mode fiber for the two LP modes, an LP01 mode which is the base mode and an LP11 mode which is a higher mode are excited. Further, by utilizing two degenerate modes of the LP11 mode (these are referred to as LP11a and LP11b) and polarization modes of each of the modes (these are referred to as X polarization and Y polarization), in the multi-mode fiber for two LP modes, different pieces of information can be superimposed in a total of six spatial modes of LP01X, LP01Y, LP11ax, LP11aY, LP11bX, and LP11bY. Therefore, if the nonlinear optical effect of an optical fiber is ignored, the multi-mode fiber for two LP modes can, in principle, achieve a transmission capacity three times larger than that of an existing single mode fiber.

As described above, in the space-division-multiplexed transmission technique in which different pieces of independent information are superimposed on propagation light in each spatial mode of the multi-mode optical fiber, improvement in transmission capacity per optical fiber can be expected according to the number of exciting spatial modes, and there is a global trend in research and development by related organizations for practical use in order to implement a future large-capacity optical backbone network.

The MIMO type signal processing requires a function to compensate not only for coupling between spatial modes but also for so-called dispersion, a phenomenon caused by delay differences in signal pulses on the time axis. The dispersion described here is a phenomenon caused by a group delay difference between guided modes, and refers to, for example, polarization mode dispersion occurring in a case of a single mode optical fiber or mode dispersion occurring in a case of a multi-mode optical fiber.

In general, since dispersion has a cumulative characteristic depending on a transmission distance, in the MIMO type signal processing for an optical signal transmitted over a long distance, it is necessary to apply MIMO type signal processing that has a finite impulse response (FIR) with the number of multipliers (the number of taps) which sufficiently covers the temporal spread of signal pulses due to dispersion (hereinafter, this processing will be described as MIMO-FIR type signal processing). That is, the required number of taps increases in accordance with the transmission distance, and as a result, the scale of the signal processing circuit increases.

As an effective method of reducing the scale of the signal processing circuit for the MIMO-FIR type signal processing described above, frequency domain MIMO-FIR type signal processing in which signal processing in a time domain is performed in a frequency domain is known (refer to Non Patent Literature 1 and Non Patent Literature 2). The frequency domain MIMO-FIR type signal processing is a processing method that effectively reduces the signal processing scale in the MIMO-FIR type signal processing by applying processing via fast Fourier transform based on a fact that the cyclic convolution operation is equivalent processing to the element product operation in the frequency domain. By the MIMO-FIR type signal processing, it is possible to collectively compensate for separation of coupling between the spatial modes including polarization and dispersion generated in the fiber as a transmission line.

### CITATION LIST

### Non Patent Literature

Non Patent Literature 1: Mansour, D., & Gray, A. (1982). Unconstrained frequency-domain adaptive filter. IEEE Transactions on Acoustics, Speech, and Signal Processing, 30(5), 726-734.
Non Patent Literature 2: Md. Saifuddin Faruk and Kazuro Kikuchi, “Adaptive frequency-domain equalization in digital coherent optical receivers”, Opt. Express 19, 12789-12798 (2011)

### SUMMARY OF INVENTION

### Technical Problem

In the frequency domain MIMO-FIR type signal processing in the related art, a block-processing-type overlap saving method has been used (for example, the method described in Non Patent Literature 2). An overlap ratio described herein refers to a ratio of the number of input signal samples included in an overlapping manner between a block number k and a block number k+1 in the processing of the overlap saving method.

In the processing of the overlap saving method, assuming that a length of one block in the block processing is N (N is a natural number), generally, N is a number of powers of 2 which is sufficiently larger than 1 and by which the Fourier transform processing can be efficiently performed by using the fast Fourier transform processing. In addition, the frequency domain MIMO-FIR type signal processing based on the overlap saving method is normally operated at an overlap ratio of 50%, and N=2 PM (hereinafter, referred to as “expression 1”) is set. Here, M is the number of output symbols per block, and P is an oversampling rate of the input signal. In addition, the overlap ratio 50% is a ratio that is set as a condition under which the intra-block interference does not occur in the output signals and the update results of the filter weighting coefficients according to the overlap saving method.

FIG. 9 is a diagram illustrating correspondence between an input signal sequence and an output signal sequence in the frequency domain MIMO-FIR type signal processing with the overlap ratio of 50% in the related art. For a k-th block, the second half N/2 symbol is stored as the output signal. Similarly, for a (k+1)-th block, the second half N/2 symbol is stored as the output signal. The output signals obtained in each of the connected blocks are connected, and thus a continuous output signal sequence is obtained.

A tap length L defining FIR type filtering processing is associated with L=PM (hereinafter, referred to as “expression 2”), and is generally set according to a storage length of a transmission line channel for compensation. In a case of the optical fiber communication being considered now, the tap length L is set so as to be able to sufficiently compensate for the spread of the impulse responses generated by the dispersion phenomenon. In addition, as another requirement condition for the tap length L, there is a condition that N is a power of 2 in consideration of (expression 1).

In view of the above-described setting conditions, when the frequency domain MIMO-FIR type signal processing based on the fast Fourier transform processing is applied to a long-distance optical fiber communication system or the like, a discrete increase in the tap length L is caused. As an example, a case where the tap length required to compensate for the dispersion phenomenon at a distance D1=D is L and where the tap length required to compensate for the dispersion phenomenon at a distance D2=D+ΔD is L+ΔL is considered.

The required block length N(D2) at the distance D2 is set to N(D2)=2 (L+ΔL) (hereinafter, referred to as “expression 3”) when ΔL<L is satisfied based on (expression 1), but is set to N(D2)=4L (hereinafter, referred to as “expression 4”) in actual operation due to the requirement that the block length of the fast Fourier transform processing is a power of 2.

Therefore, in the frequency domain MIMO-FIR type signal processing with the overlap ratio of 50% in the related art, discrete (discontinuous) increases occur in the block length N and the tap length L, which are processing parameters, from the distance D1 to the distance D2. That is, the required conditions for the processing parameters are not consistent between the physical dispersion phenomenon and the calculation efficiency for the fast Fourier transform processing. In particular, there is a problem that the output symbol M obtained by the frequency domain MIMO-FIR type signal processing with the overlap ratio of 50% in the related art is set too low and this results in a decrease in calculation efficiency.

In view of the above circumstances, an object of the present invention is to provide a technique capable of reducing an amount of calculation.

### Solution to Problem

According to an aspect of the present invention, there is provided a signal processing device including: a Fourier transform processing unit that converts an input signal into a frequency domain signal for each block having a size N; a multiplication processing unit that performs filtering processing on the frequency domain signal converted by the Fourier transform processing unit by using a filter weighting coefficient; an inverse Fourier transform processing unit that performs inverse Fourier transform processing on the frequency domain signal on which the filtering processing is performed by the multiplication processing unit; and an output signal selection unit that stores N/2+Δ (Δ is a positive integer) symbols centered on an N/2-th output symbol from the head among output symbols having a size N which are obtained by performing inverse Fourier transform processing by the inverse Fourier transform processing unit, and outputs a signal obtained by discarding output symbols other than the stored output symbols.

According to another aspect of the present invention, there is provided a signal processing method including: a Fourier transform processing step of converting an input signal into a frequency domain signal for each block having a size N; a multiplication processing step of performing filtering processing on the frequency domain signal converted by the Fourier transform processing step by using a filter weighting coefficient; an inverse Fourier transform processing step of performing inverse Fourier transform processing on the frequency domain signal on which the filtering processing is performed by the multiplication processing step; and an output signal selection step of storing N/2+Δ (Δ is a positive integer) symbols centered on an N/2-th output symbol from the head among output symbols having a size N which are obtained by performing inverse Fourier transform processing by the inverse Fourier transform processing step, and outputting a signal obtained by discarding output symbols other than the stored output symbols.

### Advantageous Effects of Invention

According to the present invention, it is possible to reduce an amount of calculation.

### BRIEF DESCRIPTION OF DRAWINGS

FIG. 1 A block diagram illustrating a configuration of a signal processing device.

FIG. 2 A diagram illustrating a correspondence relationship between an input signal sequence and an output signal sequence.

FIG. 3 A flowchart illustrating a flow of processing of the signal processing device.

FIG. 4A A diagram illustrating a filter weighting coefficient W and an error signal E in the technique in the related art.

FIG. 4B A diagram illustrating a filter weighting coefficient W and an error signal E in the present embodiment.

FIG. 5A A diagram illustrating an overlap ratio in the technique in the related art.

FIG. 5B A diagram illustrating an overlap ratio in the present embodiment.

FIG. 6 A diagram illustrating a calculation amount reduction rate.

FIG. 7 A diagram illustrating the number of symbols per block in a case of a weakly-coupled fiber.

FIG. 8 A diagram illustrating the number of symbols per block in a case of a strongly-coupled fiber.

FIG. 9 A diagram illustrating correspondence between an input signal sequence and an output signal sequence in frequency domain MIMO-FIR type signal processing with an overlap ratio of 50% in the related art.

### DESCRIPTION OF EMBODIMENTS

An embodiment of the present invention will be described in detail with reference to the drawings.

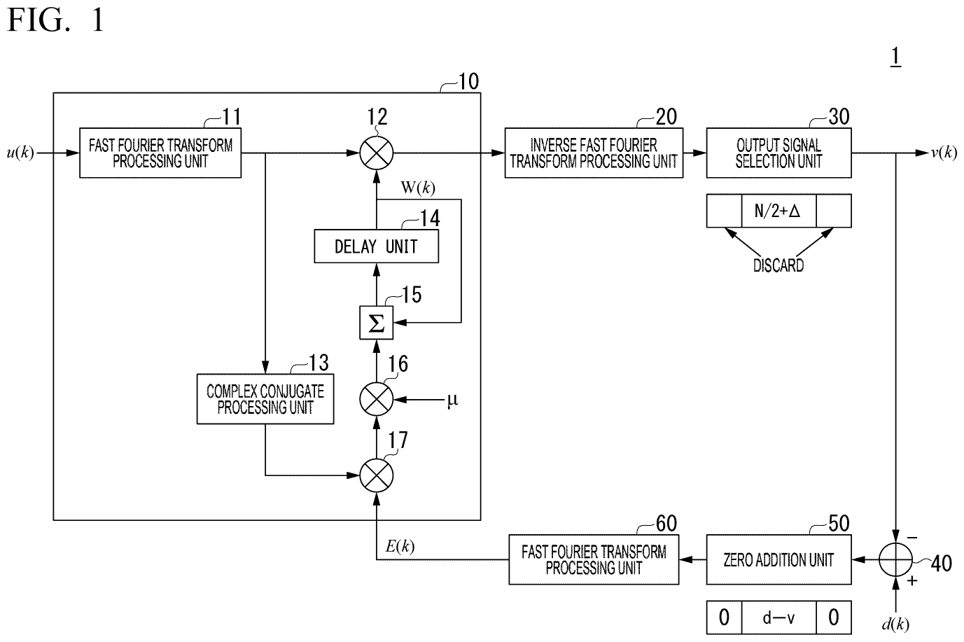

FIG. 1 is a block diagram illustrating a configuration of a signal processing device 1 according to the embodiment. The signal processing device 1 is a signal processing device that performs adaptive filter equalization processing in a reception device that receives an optical signal. Note that the configuration illustrated in FIG. 1 illustrates a configuration of single-input single-output (SISO) in order to simply describe the frequency domain MIMO-FIR type signal processing. This configuration can be easily extended to the MIMO type by arranging the filtering processing units 10 in parallel according to the number of input signal sequences.

Next, u(k), v(k), W(k), and d(k) illustrated in FIG. 1 will be described. u is an input signal sequence of a k-th block in the time domain. v is an output signal sequence of a k-th block in the time domain. w is a filter weighting coefficient of a k-th block. d is a desired signal of a k-th block. In addition, it is assumed that a block length is N. Further, the oversampling rate P of the input signal is usually set to P=2 for the optical transmission signal. On the other hand, as in the method described in Non Patent Literature 2, in a case of parallelizing the input signal into P sequences (that is, P=1), generality is not lost. Therefore, P=1 is assumed for the sake of simplicity in the following description also in the present embodiment. On the other hand, it is assumed that the number M of output symbols is set to M=N/2+Δ (Δ is an integer equal to or smaller than N/2 and equal to or larger than 1).

The signal processing device 1 includes a filtering processing unit 10, an inverse fast Fourier transform processing unit 20, an output signal selection unit 30, an addition processing unit 40, a zero addition unit 50, and a fast Fourier transform processing unit 60. The filtering processing unit 10 includes a fast Fourier transform processing unit 11, a multiplication processing unit 12, a complex conjugate processing unit 13, a delay unit 14, a filter weighting coefficient updating unit 15, and multiplication processing units 16 and 17.

The fast Fourier transform processing unit 11 converts the input signal sequence u into a frequency domain signal U by the following expression (1) and outputs the frequency domain signal U to the multiplication processing unit 12 and the complex conjugate processing unit 13. In the following expression (1), FFT( ) represents fast Fourier transform processing.

$$U = FFT ( u ) \qquad ( 1 )$$

The complex conjugate processing unit 13 outputs U* obtained by taking the complex conjugate of the input frequency domain signal U to the multiplication processing unit 17. The multiplication processing unit 17 outputs, to the multiplication processing unit 16, U*. E obtained by taking an element product (Hadamard product) of E(k) to be described later and U*, E(k) being output from the inverse fast Fourier transform processing unit 20. Here, the symbol “·” indicates an operator of the element product.

The multiplication processing unit 16 outputs μU*·E obtained by multiplying a step size parameter u by U*. E to the filter weighting coefficient updating unit 15. The filter weighting coefficient updating unit 15 calculates W+μU*·E using W(k) and updates the filter weighting coefficient by setting the calculated value as W again. The filter weighting coefficient updating unit 15 outputs the updated W to the delay unit 14. The delay unit 14 delays W by a predetermined timing and outputs W to the multiplication processing unit 12. The multiplication processing unit 12 outputs U·W obtained by taking the element product of U and W to the inverse fast Fourier transform processing unit 20.

The inverse fast Fourier transform processing unit 20 converts U·W into an output signal v by the following expression (2) and outputs the output signal v to the output signal selection unit 30. In the following expression (2), IFFT( ) represents inverse fast Fourier transform processing.

$$v = IFFT ( U \cdot W ) \qquad ( 2 )$$

The output signal selection unit 30 stores the center N/2+Δ components of v=IFFT(U·W). On the other hand, the output signal selection unit 30 discards the other N/2−Δ components. The output signal sequence v output from the output signal selection unit 30 is output from the signal processing device 1 to the subsequent stage, and is also output to the addition processing unit 40. In the technique in the related art, the first half N/2 components of v=IFFT(U·W) are discarded, and the second half N/2 components are stored.

The addition processing unit 40 outputs a difference d-v between a desired signal d and the output signal sequence v to the zero addition unit 50. The zero addition unit 50 adds 0 to d−v by setting the components corresponding to the discarded output symbols to 0, and outputs the result to the fast Fourier transform processing unit 60. The fast Fourier transform processing unit 60 corresponds to another Fourier transform processing unit. The fast Fourier transform processing unit 60 obtains a frequency domain error signal E by the following expression (3). The fast Fourier transform processing unit 60 outputs the error signal E to the multiplication processing unit 17.

$$[ Math . 1 ]$$

$$E = FFT ( [ {0}_{\frac{N}{4} - ⌈ \frac{Δ}{2} ⌉ + 1 ,} d - v , {0}_{\frac{N}{4} + ⌊ \frac{Δ}{2} ⌋ ,} ] ) \qquad ( 3 )$$

$$( ⌈ ⌉ indicates a ceiling function , and ⌊ ⌋ indicates a floor function )$$

W is updated through the complex conjugate processing unit 13, the multiplication processing unit 17, the multiplication processing unit 16, and the filter weighting coefficient updating unit 15 for the processing at the block number k+1 of the next block.

In the configuration illustrated in FIG. 1 described above, similarly to the technique in the related art, as an example of the filter coefficient update algorithm, an implementation example of a frequency domain least mean square (LMS) type method without constraint (refer to Non Patent Literature 1) has been described. As another example of the filter coefficient update algorithm that can be applied in the filtering processing unit, there are a frequency domain LMS type method with constraint and a frequency domain recursive least square (RLS) method. For the RLS method, the following document is referred to.

Zhiqun Yang, Jian Zhao, Neng Bai, Ezra Ip, Ting Wang, Zhihong Li, and Guifang Li, “Experimental demonstration of adaptive VFF-RLS-FDE for long-distance mode-division multiplexed transmission”, Opt. Express 26, 18362-18367 (2018)

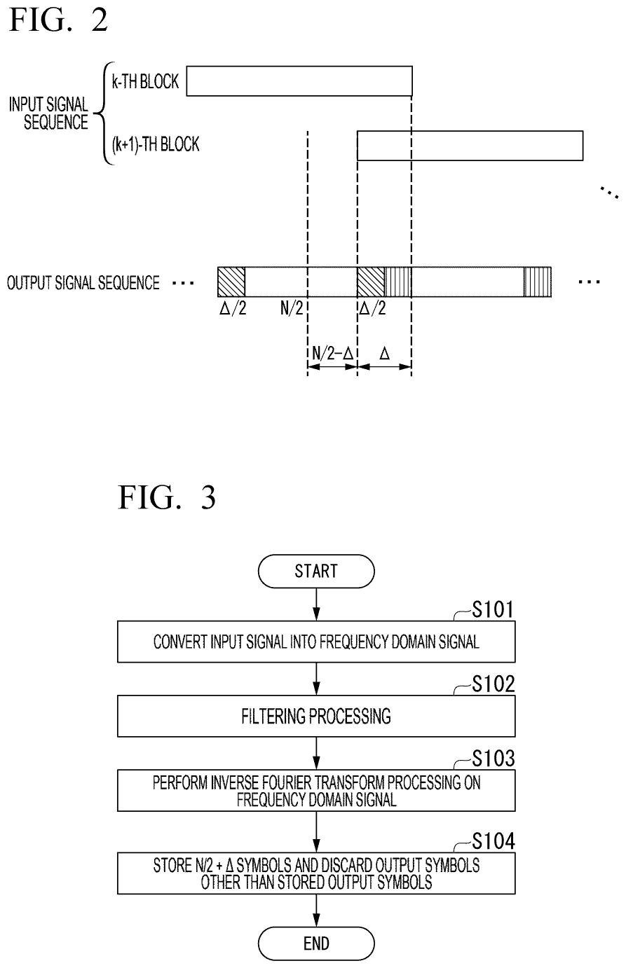

FIG. 2 is a diagram illustrating a correspondence relationship between an input signal sequence and an output signal sequence in the frequency domain MIMO-FIR type signal processing described above. FIG. 2 illustrates a k-th block and a (k+1)-th block as the input signal sequence. Further, an output signal sequence is illustrated corresponding to the input signal sequence.

In the k-th block illustrated in FIG. 2, the N/2+Δ symbols, which are obtained by adding Δ symbols and N/2 symbols centered on the N/2-th output symbol from the head among the output symbols having the size N, are stored as the output signal. It is possible to reduce the overlap ratio by this increment corresponding to Δ symbols, and the overlap ratio at this time is given by the following expression (4).

$$Overlap ratio = Δ / N \qquad ( 4 )$$

That is, since Δ is an integer equal to or smaller than N/2, the input signal sequence of the (k+1)-th block can be configured in such a manner that the overlap ratio is reduced by 50%. Here, it should be noted that the method in the related art described with reference to FIG. 9 and the method described in the present embodiment described with reference to FIG. 1 have the same “signal processing scale (complex multiplication number) per block”. On the other hand, the number of output symbols per block is increased in the present embodiment. Therefore, according to the present embodiment, the “signal processing scale per output symbol” can be effectively reduced.

FIG. 3 is a flowchart illustrating a flow of processing of the signal processing device 1 described above. The fast Fourier transform processing unit 11 converts the input signal into a frequency domain signal for each block having the size N (step S101). The multiplication processing unit 12 performs filtering processing on the frequency domain signal converted by the fast Fourier transform processing unit 11 by using the filter weighting coefficient (step S102). The inverse fast Fourier transform processing unit 20 performs inverse Fourier transform processing on the frequency domain signal on which the filtering processing has been performed by the multiplication processing unit 12 (step S103). The output signal selection unit 30 stores N/2+Δ (Δ is a positive integer) symbols centered on the N/2-th output symbol from the head among the output symbols having the size N obtained by performing the inverse Fourier transform processing by the inverse fast Fourier transform processing unit 20, and outputs a signal obtained by discarding output symbols other than the stored output symbols (step S104).

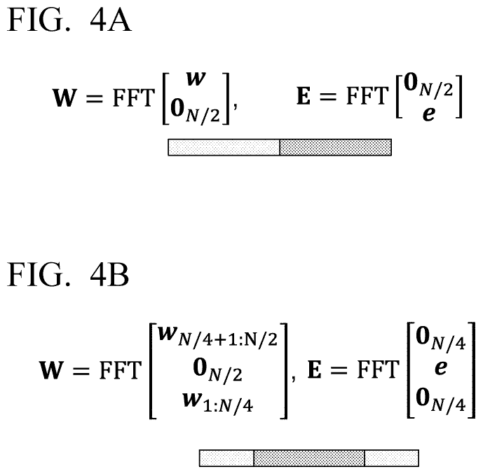

Next, the present embodiment described above and the technique in the related art will be compared and explained. First, FIG. 4Δ is a diagram illustrating a filter weighting coefficient W and an error signal E in the technique in the related art. As illustrated in FIG. 4A, W is a value obtained by performing fast Fourier transform processing on N/2 pieces of w and a zero vector including N/2 pieces of 0. E is obtained by performing fast Fourier transform processing on a zero vector including N/2 pieces of 0 and the difference e between the desired signal d and the output signal sequence v.

FIG. 4B is a diagram illustrating the filter weighting coefficient W and the error signal E in the present embodiment. As illustrated in FIG. 4B, W is obtained by performing fast Fourier transform processing on N/2 pieces of w, a zero vector including N/2 pieces of 0, and N/2 pieces of w. E is obtained by performing fast Fourier transform processing on a zero vector including N/4 pieces of 0, the difference e between the desired signal d and the output signal sequence v, and a zero vector including N/4 pieces of 0. Compared with the technique in the related art, in the present embodiment, the algorithm is modified such that the output symbols which are not subject to intra-block interference are arranged in the center.

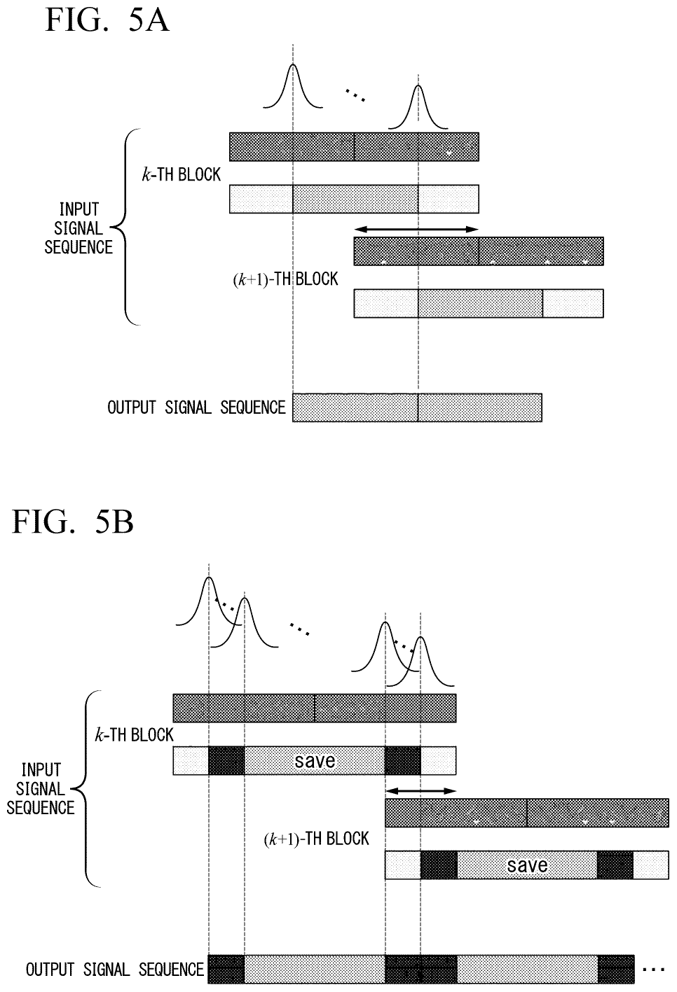

Next, the overlap ratio will be described by comparing the present embodiment and the technique in the related art. FIG. 5A is a diagram illustrating an overlap ratio in the technique in the related art. FIG. 5A illustrates a k-th block and a (k+1)-th block. Further, an output signal sequence is illustrated corresponding to the input signal sequence. As illustrated in FIG. 5A, the overlap ratio in the technique in the related art is 50%.

FIG. 5B is a diagram illustrating an overlap ratio in the present embodiment. FIG. 5B illustrates a k-th block and a (k+1)-th block. Further, an output signal sequence is illustrated corresponding to the input signal sequence. As illustrated in FIG. 5B, the overlap ratio can be reduced to a range (up to 25%) that is not effectively affected by the intra-block interference.

Next, a calculation amount reduction rate compared with the technique in the related art will be described. In the following description, the frequency domain MIMO-FIR type signal processing with the overlap ratio of 50%, which is the technique in the related art, is expressed as a method A. The frequency domain MIMO-FIR type signal processing in which the overlap ratio is reduced according to the present embodiment is expressed as a method B.

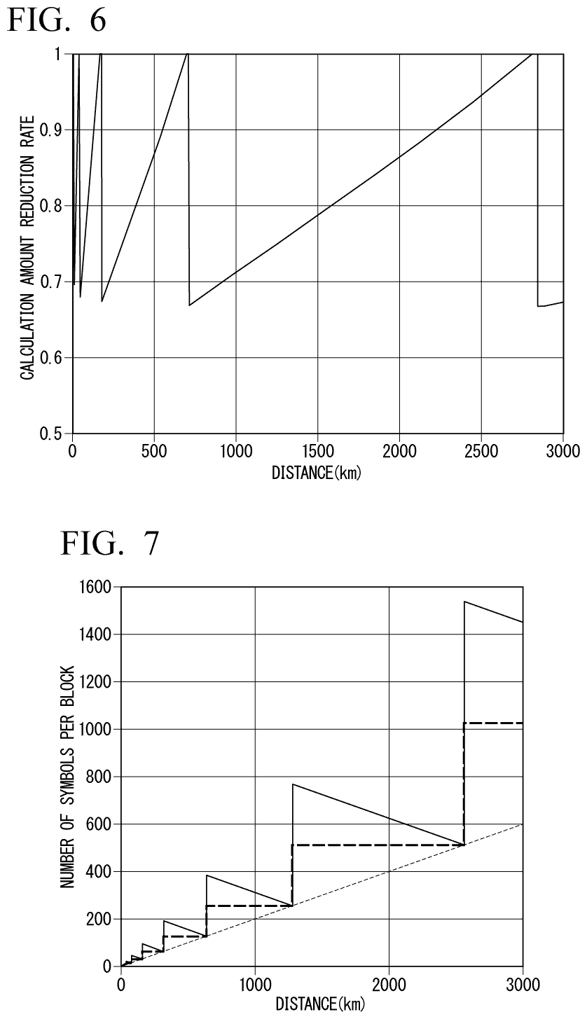

FIG. 6 is a diagram illustrating a calculation amount reduction rate. In the graph illustrated in FIG. 6, a horizontal axis represents a distance, and a vertical axis represents a calculation amount reduction rate. The calculation amount reduction rate is defined as a value obtained by dividing the signal amount required for the method B by the signal processing scale of the method B. In addition, in the calculation amount reduction rate illustrated in FIG. 6, a complex multiplication number is used as a parameter representing the calculation amount. Further, the complex multiplication number required for the (inverse) fast Fourier transform processing on the signal having the block length N (N is a power of 2) at that time is set to N/2×log (N) (the base of the logarithm is 2). In addition, it is assumed that a coupled multicore fiber of which the number of cores is 12 is used as a type of an optical fiber forming the optical transmission line. The symbol rate of the signal is set to 10 GBaud. The oversampling rate is set to 2. The spatial mode dispersion coefficient is set to 20 ps/(km)\hat{ }½. The symbol “\hat{ }” represents a power, and in this case, represents a square root.

In FIG. 6, a triangular waveform graph of the calculation amount reduction rate is repeatedly illustrated. This transition represents a point at which the block length based on the fast Fourier transform processing transitions to a power of 2. In addition, the value of A is set to a condition under which no intra-block interference occurs. As illustrated in FIG. 6, vertexes other than the vertexes located on the triangular waveforms have a value lower than 1. That is, it is shown that the calculation amount can be reduced by the present embodiment. The average value of the calculation amount reduction rates between the distances of 1 km to 3000 km illustrated in FIG. 6 is 0.82. As described above, according to the present embodiment, the amount of calculation can be reduced as compared with the technique in the related art.

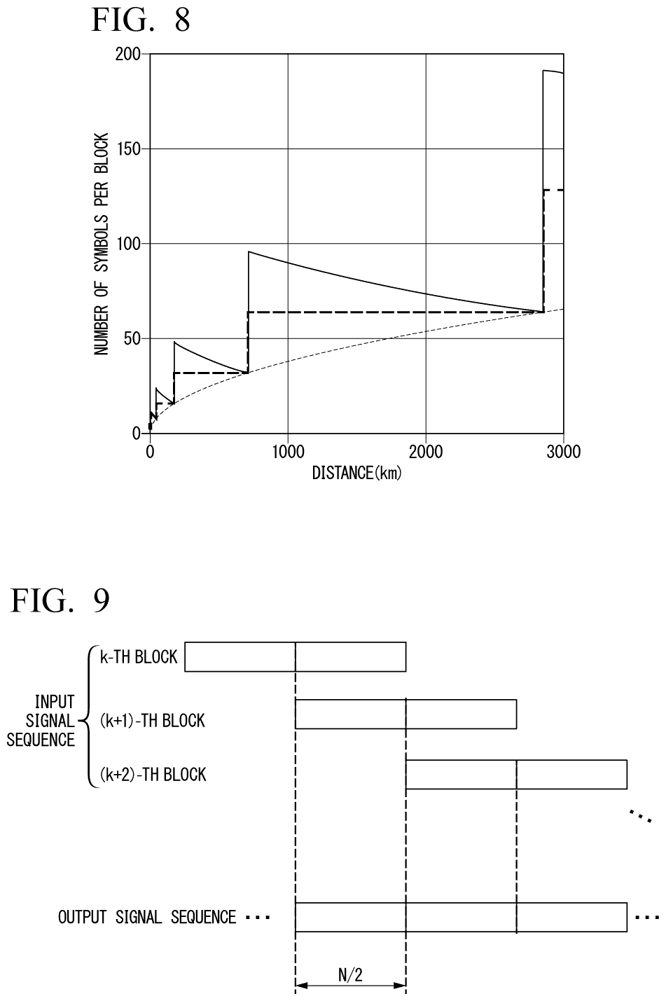

Next, the number of symbols per block compared with the technique in the related art in a case of frequency domain equalization (FDE)-least-mean square (LMS) without the constraint condition will be described. FIG. 7 is a diagram illustrating the number of symbols per block in a case of a weakly-coupled fiber. FIG. 8 is a diagram illustrating the number of symbols per block in a case of a strongly-coupled fiber. In FIG. 7 and FIG. 8, a horizontal axis represents a distance, and a vertical axis represents the number of symbols per block. In addition, a solid line indicates the number of symbols per block in a case where the present embodiment is applied, and a broken line indicates the number of symbols per block in a case where the technique in the related art is applied.

In the calculation condition for the number of symbols per block illustrated in FIG. 7, the SMD coefficient is set to 20 ps/km, the symbol rate is set to 10 GBaud, the number of modes is set to 12, and the scaling coefficient is set to 1. In the calculation condition for the number of symbols per block illustrated in FIG. 8, the SMD coefficient is set to 20 ps/km, the symbol rate is set to 10 GBaud, the number of modes is set to 12, and the scaling coefficient is set to 6.

As illustrated in FIG. 7 and FIG. 8, it can be seen that the number of symbols per block according to the present embodiment exceeds that of the technique in the related art almost everywhere in the distance.

As described above, the embodiment of the present invention has been described in detail with reference to the drawings. On the other hand, specific configurations are not limited to the embodiment, and include design and the like within the scope of the present invention without departing from the gist of the present invention.

### INDUSTRIAL APPLICABILITY

The present invention can be applied to a reception device that receives an optical signal.

### REFERENCE SIGNS LIST

1 Signal processing device
10 Filtering processing unit
11 Fast Fourier transform processing unit
12 Multiplication processing unit
13 Complex conjugate processing unit
14 Delay unit
15 Filter weighting coefficient updating unit
16 Multiplication processing unit
17 Multiplication processing unit
20 Inverse Fourier transform processing unit
30 Output signal selection unit
40 Addition processing unit
50 Zero addition unit
60 Fast Fourier transform processing unit

1. A signal processing device comprising:
a Fourier transform processing circuitry that converts an input signal into a frequency domain signal for each block having a size N;
a multiplication processing circuitry that performs filtering processing on the frequency domain signal converted by the Fourier transform processing circuitry by using a filter weighting coefficient;
an inverse Fourier transform processing circuitry that performs inverse Fourier transform processing on the frequency domain signal on which the filtering processing is performed by the multiplication processing circuitry; and
an output signal selection circuitry that stores N/2+Δ (Δ is a positive integer) symbols centered on an N/2-th output symbol from the head among output symbols having a size N which are obtained by performing inverse Fourier transform processing by the inverse Fourier transform processing circuitry, and outputs a signal obtained by discarding output symbols other than the stored output symbols.

2. The signal processing device according to claim 1, further comprising:
a zero addition circuitry that outputs a signal obtained by adding zero to a difference vector obtained from a difference between the signal output by the output signal selection circuitry and a desired signal,
wherein the zero addition circuitry sets components corresponding to the output symbols discarded by the output signal selection circuitry to zero.

3. The signal processing device according to claim 2, further comprising:
another Fourier transform processing circuitry that outputs a signal obtained by performing Fourier transform on the signal to which zero is added by the zero addition circuitry.

4. The signal processing device according to claim 3, further comprising:
a complex conjugate processing circuitry that performs complex conjugate processing on the signal output by the Fourier transform processing circuitry; and
an updating circuitry that updates the filter weighting coefficient by using the signal on which complex conjugate processing is performed by the complex conjugate processing circuitry and the signal output by the another Fourier transform processing circuitry.

5. A signal processing method comprising:
converting an input signal into a frequency domain signal for each block having a size N;
performing filtering processing on the frequency domain signal converted by the converting by using a filter weighting coefficient;
performing inverse Fourier transform processing on the frequency domain signal on which the filtering processing is performed by the performing the filtering processing; and
storing N/2+Δ (Δ is a positive integer) symbols centered on an N/2-th output symbol from the head among output symbols having a size N which are obtained by performing inverse Fourier transform processing by the performing the inverse Fourier transform processing, and outputting a signal obtained by discarding output symbols other than the stored output symbols.
